(19) United States
(12) Patent Application Publication
(10) Pub. No.: US 2008/0028118 A1
(43) Pub. Date: Jan. 31, 2008

(54) Portable dock for a portable computing system

(76) Inventors: Craig Peter Sayers, Palo Alto, CA (US); Jeffery Aaron Lev, Palo Alto, CA (US); Jeff Parker, Magnolia, TX (US); Ian Nevill Robinson, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/496,987

(22) Filed: Jul. 31, 2006

(51) Int. Cl. G06F 13/00

(52) U.S. Cl. 710/303

(57) ABSTRACT

A portable dock for a portable computing system is disclosed. The portable dock includes a hand carryable housing for attaching to a docking port of a portable computing system, wherein the housing is not required to enclose the portable computing system. A power supply transformer is also coupled with the housing. Additionally, a network connectivity module is coupled with the housing, wherein the network connectivity module is a wired network connectivity module when the portable computing device is coupled with the portable dock and wherein the network connectivity module is a wireless network connectivity module when the portable computing system is not coupled with the portable dock.

### TECHNICAL FIELD

The present invention pertains to a portable dock for a portable computing system.

### BACKGROUND

Presently, portable computing systems, such as laptops, notebooks, and the like, are present throughout day-to-day life. Portable computing systems are widely used by travelers as entertainment and as a means for working. Generally, the portable computing systems are used before traveling, while traveling and after arriving at a destination.

Moreover, because of the significant increase in portable computing system capabilities and conveniences, many computer users that rarely travel are also transitioning to portable devices. For example, a computer user that does not significantly travel for work may own a portable computing device because of the reduced footprint of the portable computing system. Due to the capabilities of present portable computing devices, most computer users don't even realize any operational shortcomings when using a portable system as compared to a desktop computing system.

However, one of the shortcomings of portable computing devices is the need to carry the power cable and other associated devices when traveling. For example, a portable computing system user that is traveling has a defined battery life. Therefore, when traveling, the user will often carry peripheral devices such as a power adapter and plug it in whenever possible to conserve and recharge the associated batteries. Moreover, when traveling, the user may also need to carry an Ethernet cord for connecting to networks, as well as a mouse, etc.

Generally, carrying one or more of the peripheral devices can be very awkward and is liable to generate a lot of user frustration. For example, the power adaptor and cable take up a lot of space and weigh a fair amount. It can take some time to unwrap the cord for use and re-wrap the cord for stowage. Moreover, it is not uncommon to forget the power adapter, the Ethernet cord, or other peripherals when packing up or changing locations.

Furthermore, when using a portable computing device while traveling, the power outlet and Ethernet jack may be in a location within the room that the user does not wish to occupy. For example, the power outlet and Ethernet jack may be in a corner at a desk, while the user was hoping to work from a different location. For example, the user may want to eat at the table or sit on the couch or bed while operating the computing device.

### DISCLOSURE OF THE INVENTION

A portable dock for a portable computing system is disclosed. The portable dock includes a hand carryable housing for attaching to a docking port of a portable computing system, wherein the housing is not required to enclose the portable computing system. A power supply transformer is also coupled with the housing. Additionally, a network connectivity module is coupled with the housing, wherein the network connectivity module is a wired network connectivity module when the portable computing device is coupled with the portable dock and wherein the network connectivity module is a wireless network connectivity module when the portable computing system is not coupled with the portable dock.

### BRIEF DESCRIPTION OF THE DRAWINGS

The accompanying drawings, which are incorporated in and form a part of this application, illustrate embodiments of the present invention, and together with the description, serve to explain the principles of the invention. Unless noted, the drawings referred to this description should be understood as not being drawn to scale.

FIG. 1A is a top perspective view of an exemplary portable dock according to one embodiment of the present invention.

FIG. 1B is a bottom perspective view of an exemplary portable dock according to one embodiment of the present invention.

FIG. 1C is a rear perspective view of an exemplary portable dock according to one embodiment of the present invention.

FIG. 1D is a side perspective view of an exemplary portable dock according to one embodiment of the present invention.

FIG. 2A is a side perspective view of an exemplary portable dock coupled with an exemplary portable computing device according to one embodiment of the present invention.

FIG. 2B is a bottom perspective view of an exemplary portable dock coupled with an exemplary portable computing device according to one embodiment of the present invention.

FIG. 2C is a rear perspective view of an exemplary portable dock coupled with an exemplary portable computing device according to one embodiment of the present invention.

FIG. 3 is a top see-through view of an exemplary portable dock according to one embodiment of the present invention.

FIG. 4 is a top see-through view of an exemplary portable dock according to another embodiment of the present invention.

FIG. 5A is a top perspective view of one exemplary operational connection of an exemplary portable dock coupled with an exemplary portable computing device according to one embodiment of the present invention.

FIG. 5B is a top perspective view of one exemplary operational connection of an exemplary portable dock wirelessly coupled with an exemplary portable computing device according to one embodiment of the present invention.

FIG. 6 is a flowchart of an exemplary method for using a portable dock to increase portability of a portable computing system in accordance with one embodiment of the present invention.

FIG. 7 is a block diagram of an exemplary portable dock system in accordance with one embodiment of the present invention.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, objects, and circuits have not been described in detail as not to unnecessarily obscure aspects of the present invention.

Aspects of the present invention may be practiced on a computer system that includes, in general, a processor for processing information and instructions, random access (volatile) memory (RAM) for storing information and instructions, read-only (non-volatile) memory (ROM) for storing static information and instructions, a data storage device such as a magnetic or optical disk and disk drive for storing information and instructions, an optional user output device such as a display device (e.g., a monitor) for displaying information to the computer user, an optional user input device such as, but not limited to, alphanumeric and function keys (e.g., a keyboard), pen and touch screen systems, optical driven systems and voice systems for communicating information and command selections to the processor, and an optional user input device such as a cursor control device (e.g., a mouse) for communicating user input information and command selections to the processor.

### Overview

Embodiments described herein provide an automated portable dock for a portable computing system. In general, embodiments described herein provide a portable power dock (PPD) which can be coupled with a portable computing device to significantly reduce the number of items carried in conjunction with a portable computing device. For example, in one embodiment, the PPD includes the power cord, the transformer, an Ethernet cord, and a (wired/wireless) network connectivity module. Moreover, since the PPD is coupleable with the back of the portable computing device, the apparatus of PPD and portable computing device allows a user to carry one-slightly larger portable device rather than a collection of separate items.

Furthermore, because the PPD maintains control of the plurality of appended devices, there is no opportunity for a user to forget any one of the cords, extensions, etc. In addition, because the network connectivity module is capable of operating wirelessly, the user can plug in the PPD, and then utilize the portable computing device in conjunction with the wireless network connectivity module anywhere within range of the PPD. Thus, freeing a user from the normal 3-6 foot range from an Ethernet source.

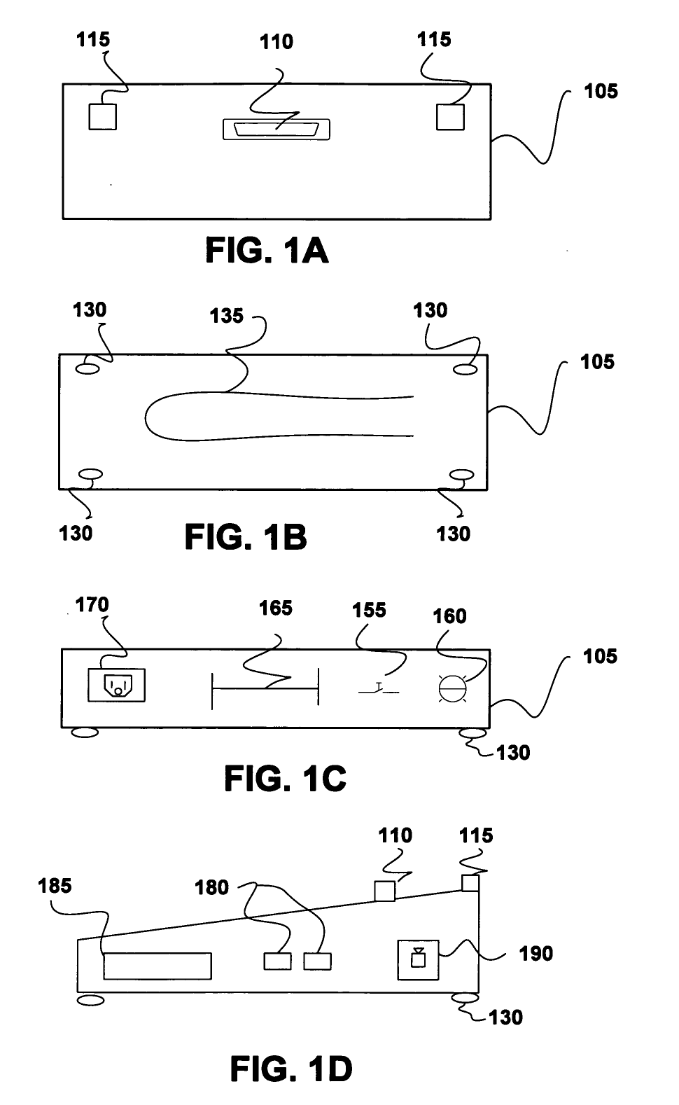

With reference now to FIG. 1A, a top perspective view of an exemplary portable dock is shown according to one embodiment of the present invention. FIG. 1A includes a housing 105. In general, the housing 105 is formed, molded, pressed, coupled or otherwise made to provide the structure for the portable dock. In general, the housing may be formed of plastic, polymer, composite, or any other material. In one embodiment, the housing is formed of a material similar to that of a portable computer case. For purposes of brevity and clarity, the housing 105 may in some cases be referred to as the portable power dock (PPD) or the hand carryable portable power dock when it is described in conjunction with the portable computing system. However, the actual PPD is the housing 105 plus any of the plurality of associated components described in detail herein.

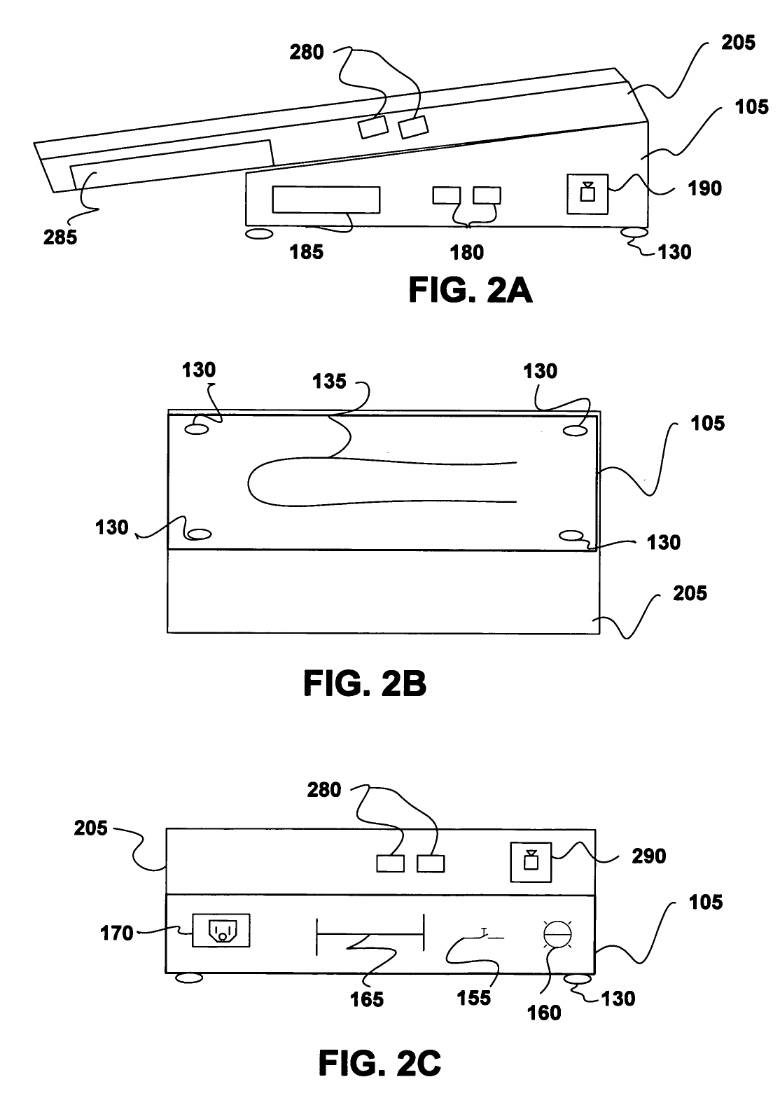

In general, the housing 105 is sized with regard to the portable computing device such that the housing 105 is coupleable with, but does not contain, the portable computing device. Moreover, housing 105 is of a shape and weight such that when it is attached with the portable computing device (as shown and further described in FIG. 2A) the resultant system is also portable and has not significantly degraded the portability of the portable computing device.

The housing 105 also includes a single connector 10 and dock connectors 115. In general, single connector 110 is an interchangeable connector that is capable of electrically connecting with a single connector of a portable computing device to allow the portable computing device to utilize all of the features of the dock. Additionally, dock connectors 115 are used to maintain the connection between the portable computing device and housing 105. Although two dock connectors 115 are shown, there may be more or fewer dock connectors 115. In addition, the dock connectors, may be of any size and shape and may be lockable, push button, or otherwise activated and deactivated.

For purposes of the present discussion, the terms portable computing device and portable computing system are also referred to herein as a laptop for purposes of brevity and clarity. In general, the terms portable computing device/system refer to a computing device that is hand carryable. Examples of a portable computing device/system include, but are not limited to laptop or notebook sized devices which may be significantly large, e.g., 17 inch display or larger, and the like for use mainly in a desk environment all the way down to laptop or notebook devices with screens which are significantly smaller, e.g., 5 inch display or smaller.

Referring now to FIG. 1B, a bottom perspective view of an exemplary portable dock is shown according to one embodiment of the present invention. In general, the bottom of housing 105 includes pads 130 and a security cable 135. In general, pads 130 are optional and provide a method for offsetting housing 105 from direct surface contact. Moreover, pads 130 may provide non-slip and non-scratch characteristics. That is, pads 130 protect both housing 105 and the surface it is on, increase airflow, and also reduce the slip characteristics of housing 105.

Housing 105 can include an attached security cable 135. In one embodiment, security cable 135 is permanently attached at one end to housing 105 and includes a lock. In operation, the security cable 135 and lock can be clipped to the underside of housing 105 for storage. When in use, the loose end of security cable 135 is unclipped, passed through an opening (e.g., the handle of a bag) and then locked into the laptop security connector. The result is security cable 135 with the laptop attached on one end and housing 105 attached on the other. So stealing either the laptop or the dock requires taking anything security cable 135 passes through. Furthermore, the use of security cable 135 does not require that the laptop be connected to the dock using the docking connectors 115.

In another embodiment, security cable 135 on housing 105 itself also allows just the PPD to be secured. For example, just wrap security cable 135 through something and then lock back to the PPD itself rather than the laptop. This secures the PPD at times, such as, when the user wishes to leave behind the PPD while carrying the laptop.

With reference now to FIG. 1C, a rear perspective view of an exemplary portable dock is shown according to one embodiment of the present invention. In one embodiment, the rear of housing 105 includes a cord storage area 170, at least one optional visual indicator 160, an optional switch 155 and an optional handle 165. Although cord storage area 170, visual indicator 160, switch 155 and handle 165 are shown in the back of housing 105 such locations are exemplary. That is, in one embodiment, the back is a useful location for providing these devices. However, the locations selected are merely for purposes of brevity and clarity, that is, the locations are shown as one of a plurality of possible configurations not as a limitation but merely for purposes of brevity and clarity.

In one embodiment cord storage area 170 is a retractable cord storage area contained within housing 105. However, in another embodiment, cord storage area 170 may be handle 165. In other words, the power cable may be on a self-retracting reel or manually wound. For example, the cord may be wrapped around handle 165 and that would result in cord storage area 170. Additionally, the handle 165 may also slide inside housing 105 (so it doesn't stick out while not in use) while the cable is or is not wrapped around it. Therefore, handle 165 may include cord storage area 170.

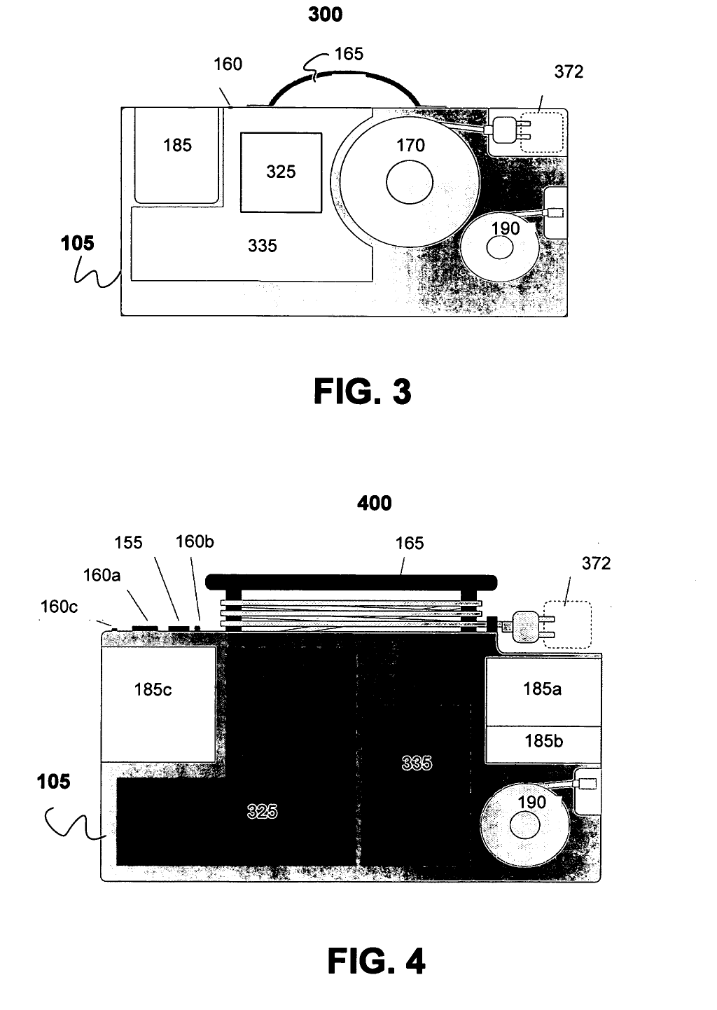

In addition, as shown in FIGS. 3 and 4, there is a recess 372 in front of the power plug so that when traveling an adaptor plug can be left attached when the cable is wound up in storage area 170. Moreover, recess 372 could also contain a dummy or live socket which could be used to hold the end of the power cable (or the adaptor) in place when the PPD is being carried. However, the power socket may also be live when the PPD is plugged in. In which case, the power socket provides a convenient additional outlet for charging/powering other accessories and the like.

Regarding the switch 155, in one embodiment, switch 155, or switches 155, may be any type of control switch and can include controls such as, but not limited to, laptop on/standby/off, wireless on/off, flight mode and the like. Moreover, visual indicator(s) 160 may be a light emitting diode (LED), bulb light, visual indicator, reflected light, or other visual indicator which may be used as an indicator to indicate power, battery status, wireless status, and the like.

Although a plurality of uses are provided herein, it is appreciated that the switches 155 and visual indicator 160 indicators could be user defined, preferences or options either pre-assigned or selectable. For example, the controls on housing 105 may be configured for use while traveling, for example, a “Flight-safe” switch or a “presentation mode” switch, and then reconfigured for different uses when not traveling.

In one embodiment, switches 155 and visual indicator(s) 160 are provided on the back of the housing 105 to overcome a shortcoming of present laptop travel configurations. For example, presently many of the visual indicators and controls which may be useful to a user are typically around the keyboard or on the front or underside of the laptop. This is valuable when a user is actually using the laptop. However, when the laptop (with attached PPD) is slid into a travel bag only the back edge of the laptop and PPD are visible. Thus, by duplicating (or initially providing) useful switch(es) or light(s) on the rear surface of the PPD housing 105, the user has a clear indication of the laptop and battery state without needing to extract the laptop from the bag.

Referring now to FIG. 1D, a side perspective view of an exemplary portable dock is shown according to one embodiment of the present invention. In one embodiment, the side of housing 105 includes an Ethernet storage area 190, port(s) 180 and storage bay(s) 185. Moreover, at the side view of housing 105 connector 110, dock connector 115, and pads 130 are also shown.

Additionally, the tapered features of housing 105 are clearly shown in FIG. 1D. Specifically, the tapered form factor having a lower front section and a higher rear section is shown. The utilization of the tapered form factor for providing an angled laptop keyboard which some users prefer is also further shown and described in conjunction with FIG. 2A. Although the housing 105 is shown with a tapered form factor in FIG. 1D, housing 105 may be any shape or style. That is, housing 105 may be formed as a tapered device but may also be formed as a flat device or any other type of shape. The use of the tapered form factor for housing 105 is one of a plurality of embodiments. The myriad of other housing 105 shapes are not shown herein merely for purposes of brevity and clarity.

In one embodiment Ethernet storage area 190 is a retractable cord storage area contained within housing 105. However, in another embodiment, Ethernet storage area 190 may be outside of housing 105. In other words, the Ethernet cable may be on a self-retracting reel or may be manually wound. For example, the cord may be wrapped around something protruding from housing 105 and that would result in Ethernet storage area 190. Additionally, the protrusion containing Ethernet storage area 190 may also slide inside housing 105 (so it doesn't stick out while not in use) while the cable is or is not wrapped around it.

Regarding the port(s) 180, in one embodiment, port(s) 180 may be any type of port such as, but not limited to, USB ports, serial ports, parallel ports, personal system PS/2 ports, VGA ports, and the like.

Regarding the storage bay(s) 185, in one embodiment, storage bay(s) 185 is one or more powered bays for holding a travel mouse, presentation remote, extra battery, iPaq, or the like. In one embodiment, storage bay(s) 185 employ a powered USB hub, such as port 180, which is built into the PPD housing 105 and connected electrically to the laptop.

An additional switch 155 on housing 105 could control whether or not the bays are powered when the laptop is docked to the PPD housing 105 but the PPD is not connected to main power.

In addition, in one embodiment, the PPD can detect when devices are inserted/removed from the storage bay(s) 185. For example, presentation mode on the laptop could automatically be engaged when the presentation remote is removed from storage bay(s) 185. Moreover, the PPD housing 105 could have a duplicate of the battery slot/connector from the laptop. This will permit an additional battery to be added. The additional battery could be charged on the PPD and then swapped with the one on the laptop. Moreover, in one embodiment, it could power the PPD itself (to power the powered-bays or the wireless connection) when the PPD is not connected to a power source.

In general, storage bay(s) 185 may be any type of slot such as, but not limited to, a power bay, a DVD-ROM, a CD-ROM, a CD-RW, a DVD-RW and the like. Additionally, in one embodiment, housing 105 may include speakers and other peripheral devices. Thus, although a plurality of peripheral connections, ports, slots, bays, storage areas, and the like are shown on and around housing 105, the present invention is well suited to more, fewer or other peripheral devices. The limitations for providing or removing devices could be user configuration selectable, weight options, standard configurations or any other type of user or manufacturer preference. The present configurations described herein are merely a few of the plurality of possible configurations available and are shown merely for purposes of brevity and clarity.

In addition, in one embodiment, housing 105 could include additional storage bays 185 such as a USB thumb drive, a USB disk drive, a hard disk drive or the like. In the case where these draw significant power (e.g., a spinning disk drive) they could be powered down by default when the PPD was not connected to an external power source.

In one embodiment, for example when using the laptop for VOIP applications, it is desirable to have additional devices dedicated to the VOIP headset. This allows the user to set one volume control for the system sounds and phone ringer and another volume control for the volume of the headset. It also enables a user to leave the headset plugged in and still hear the phone ring. Thus, in one embodiment a secondary audio device is provided (e.g., in slot 185). The secondary audio device may be a USB audio device with either a plug for a headset or a built-in retractable corded headset. Furthermore, this feature could be built into the PPD housing 105 or may be external to PPD housing 105.

In another embodiment, the secondary audio device may be a wireless headset or the like (e.g., a Bluetooth headset). Wherein slot 185 is a dedicated bay for holding/recharging the headset when not in use. Moreover, removing the headset from slot 185 could automatically start the user's VOIP application running. While stowing the headset could similarly automatically stop the user's VOIP application.

With reference now to FIG. 2A, a side perspective view of an exemplary portable dock coupled with an exemplary portable computing device is shown according to one embodiment of the present invention. In general, the side view 2A illustrates the PPD housing 105 coupled with a laptop 205. Housing 105 includes an Ethernet storage area 190, port(s) 180 and storage bay(s) 185. Moreover, at the side view of housing 105 pads 130 are also shown while connector 110 and dock connector 115 are not visible because of the docked laptop 205. Housing 105 configurations are not described in detail again for purposes of brevity and clarity. In addition, CD/DVD ROM bay 285 and ports 280 are shown on the laptop 205.

In general, FIG. 2A illustrates the orientation of the laptop 205 when coupled with the PPD housing 105. That is, the angled orientation of the laptop 205 is clearly visible. Moreover, the overall form factor and sizing differentiation between laptop 205 and PPD housing 105 are also recognizable. In general, PPD housing 105 is formed to not encase laptop 205 and not restrict access to laptop 205 while also retaining the portable characteristics of laptop 205.

Referring now to FIG. 2B, a bottom perspective view of an exemplary portable dock coupled with an exemplary portable computing device is shown according to one embodiment of the present invention. In general, the bottom view 2B is provided merely as another view of laptop 205 coupled with PPD housing 105. In one embodiment, security cable 135 and pads 130 are also visible. Housing 105 configurations are not described in detail again for purposes of brevity and clarity.

With reference now to FIG. 2C, a rear perspective view of an exemplary portable dock coupled with an exemplary portable computing device is shown according to one embodiment of the present invention. In one embodiment, the rear view 2C is provided merely as an example of one configuration of the available ports and cords of laptop 205 and PPD housing 105. In one embodiment, housing 105 includes a cord storage area 170, at least one optional visual indicator 160, an optional switch 155 and an optional handle 165. Housing 105 configurations are not described in detail again for purposes of brevity and clarity.

Additionally, in one embodiment, laptop 205 includes an Ethernet port 290 and additional ports 280. Ports 280 may be any type of port such as, but not limited to, USB ports, serial ports, parallel ports, personal system PS/2 ports, VGA ports, and the like.

Referring now to FIG. 3, a top see-through view of an exemplary portable dock is shown according to one embodiment of the present invention. In other words, FIG. 3 provides an x-ray view of housing 105 to illustrate one exemplary arrangement of the components described herein.

In one embodiment, configuration 300 of housing 105 includes a handle 165, a visual indicator 160, a storage bay 185, a transformer 325, a wired/wireless network connectivity module 335, a power cord stowage area 170, a space 372 for storing an adapter attached to the power cable 172 within the power cable stowage area 170, and an Ethernet stowage area 190. A plurality of the peripherals are previously described and not repeated herein for purposes of brevity and clarity. Moreover, it is appreciated that the organization and components shown are exemplary. That is, the present invention is well suited to shuffling of the component locations, additions or subtractions of additional components, repetition of components and the like. The present exemplary configuration is provided merely for purpose of brevity and clarity.

Although Ethernet stowage area 190 and power cord stowage area 170 are shown as retractable devices it is exemplary. For example, either one, both or neither may be retractable devices. In addition, Ethernet stowage area 190 and power cord stowage area 170 may be openings in housing 105 in which the cords can be folded and stowed or even shoved in. That is, the retractable aspect is merely one of a plurality of storage options and is shown herein merely for purposes of brevity and clarity.

Transformer 325 is a standard electrical transformer. For example, in many corded devices, the transformer is between the source, e.g., a wall outlet, and the receiver, e.g., the plug in the laptop, and is used to transform the native power into a power configuration that will not detrimentally affect the laptop. Although the transformer 325 is shown in housing 105 of configuration 300, transformer 325 may be outside of the housing 105. The illustration of transformer 325 within housing 105 is merely one of a plurality of configuration options provided for purposes of brevity and clarity.

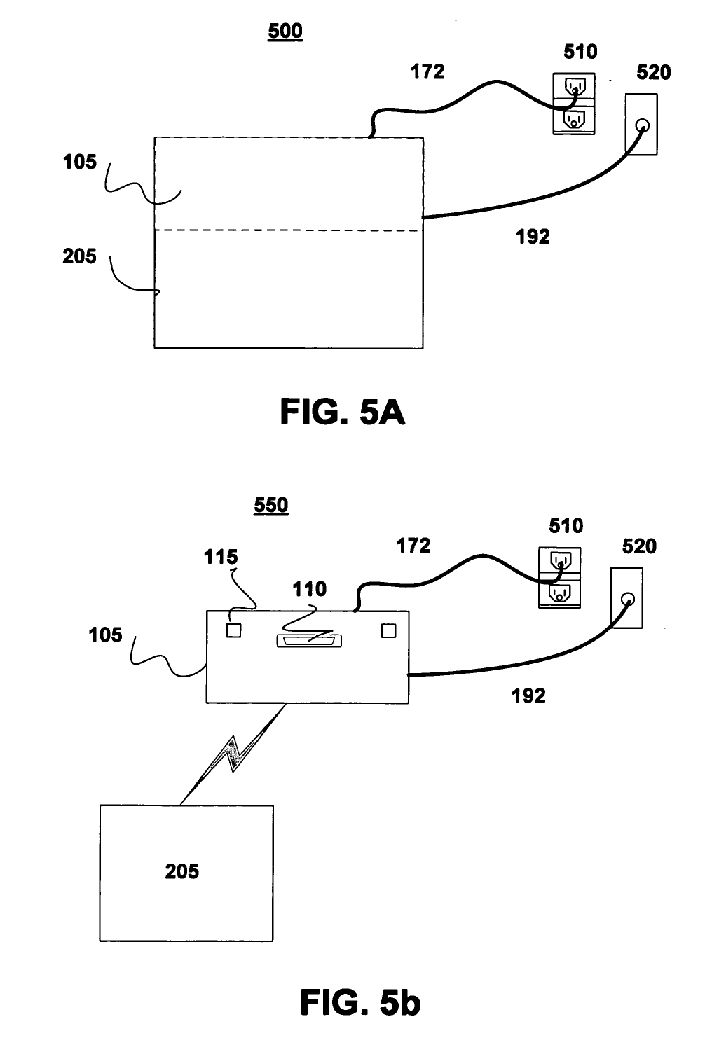

Wired/wireless network connectivity module 335 is in one embodiment, built into the PPD housing 105. In one embodiment, when the laptop 205 is docked the laptop may connect directly via the wired Ethernet connection. However, when the laptop is removed the wireless network connectivity module 335 activates and allows the user to continue to maintain a connection wirelessly. To the user the transition is seamless, so that it appears just as though they were still in the dock with the direct wired network connection. This operation is described in more detail in FIGS. 5A and 5B.

With reference now to FIG. 4, a top see-through view of an exemplary portable dock is shown according to another embodiment of the present invention. In other words, FIG. 4 provides an x-ray view of housing 105 to illustrate one exemplary arrangement of the components described herein.

In one embodiment, configuration 400 of housing 10S includes a handle 165 acting as the power cord storage location which may or may not be retractable regardless of whether or not the power cord is stored thereon. Configuration 400 of housing 105 also includes a plurality of visual indicators 160a-160c, a switch 155, a plurality of storage bays 185a-185c, a transformer 325, a wired/wireless network connectivity module 335, a space 372 for storing an adapter attached to the power cable 172, and an Ethernet stowage area 190. A plurality of the peripherals are previously described and not repeated herein for purposes of brevity and clarity. Moreover, it is appreciated that the organization and components shown are exemplary. That is, the present invention is well suited to shuffling of the component locations, additions or subtractions of additional components, repetition of components and the like. The present exemplary configuration is provided merely for purpose of brevity and clarity.

Although Ethernet stowage area 190 is shown as retractable devices and the power cord is not, it is exemplary. For example, either, both or neither may be retractable devices. In addition, Ethernet stowage area 190 may be an opening in housing 105 in which the cords can be folded and stowed or even shoved. That is, the retractable aspect is merely one of a plurality of storage options and is shown herein merely for purposes of brevity and clarity.

Transformer 325 is a standard electrical transformer such as described in FIG. 3 and not repeated for purposes of brevity and clarity. Although the transformer 325 is shown in housing 105 of configuration 400, transformer 325 may be outside of the housing 105. The illustration of transformer 325 within housing 105 is merely one of a plurality of configuration options provided for purposes of brevity and clarity.

Wired/wireless network connectivity module 335 is in one embodiment, built into the PPD housing 105. In one embodiment, when the laptop 205 is docked the laptop may connect directly via the wired Ethernet connection. However, when the laptop is removed the wireless network connectivity module 335 activates and allows the user to continue to maintain a connection wirelessly. To the user the transition is seamless, so that it appears just as though they were still in the dock with the direct wired network connection. This operation is described in more detail in FIGS. 5A and 5B.

Referring now to FIG. 5A, a top perspective view of one exemplary operational connection of an exemplary portable dock coupled with an exemplary portable computing device is shown according to one embodiment of the present invention. In general, top perspective view 5A shows a laptop 205 and provides a dotted outline of the location of housing 105 below laptop 205. Configuration 500 provides an example of the laptop 205 and PPD housing 105 connection as well as the PPD housing 105 connected with an outlet 510 via a power cord 172 and an Ethernet jack 520 via an Ethernet cord 192.

With reference now to FIG. 5B, a top perspective view of one exemplary operational connection of an exemplary portable dock wirelessly coupled with an exemplary portable computing device is shown according to one embodiment of the present invention. In general, top perspective view 5B shows a laptop 205 disconnected and communicatively coupled with PPD housing 105. Configuration 550 provides an example of the laptop 205 and PPD housing 105 wirelessly connected while the PPD housing 105 remains connected with outlet 510 via power cord 172 and Ethernet jack 520 via Ethernet cord 192.

Generally, most modern laptops already have built-in wireless support. Unfortunately many hotels and buildings provide a wired connection which causes a user to remain within a cord length of the associated outlets. Moreover, many times a wireless connection provided in a hotel, coffee shop, or the like is difficult to setup and configure. However, with respect to FIGS. 5A and 5B, the PPD described herein provides the user with a wireless option that is just as easy to use as the wired connection and provides additional functionality.

Basically, in one embodiment, network connectivity module 335 provides a connection between laptop 205 and a network when laptop 205 is connected to the PPD and between laptop 205 and the PPD when laptop 205 is disconnected from the PPD. For example, when laptop 205 is plugged into the PPD this is a wired connection. In this case, the network connectivity module 335 may directly connect laptop 205 to the network. This connection may either be to the laptop's network adaptor via wires in the docking connector or the Network Connectivity Module 335 may appear as a USB Ethernet device and connect to laptop 205 via the USB wires in the docking connector. Furthermore, the Network Connectivity Module 335 may include a networking switch or router providing additional Ethernet ports (such as the “aux” port of FIG. 7) so that other wired devices may share the single connection to the network. In one embodiment, network connectivity module 335 may also include a firewall for added security.

Thus, when laptop 205 is docked, laptop 205 may connect directly via the wired Ethernet connection. Moreover, because the network connectivity module 335 is directly connected with the PPD housing 105 any and all wireless protocols can be performed between laptop 205 and the PPD without requiring any type of user configuration operations. That is, since the laptop and PPD are periodically physically connected, that physical connection can be used to transfer security keys and other settings for use in securing/configuring the wireless connection.

Thus, when the laptop 205 is undocked from housing 105, the wireless network connectivity module 335 activates and allows the user to continue to work. To the user, the transition should be seamless, so that it appears just as though they were still in the dock with the direct wired network connection. In other words, there is no need to configure the wireless service or even notice an operational distinction. In other words, the switch from wired to wireless happens automatically when the laptop 205 is undocked and there is no need for any user configuration of the connection.

Moreover, the wired/wireless seamless operational characteristics extend to the use of any devices connected to housing 105 whether or not laptop 205 is coupled with housing 105. For example, if a USB disk drive was connected to housing 105, when laptop 205 was physically coupled with housing 105 the USB disk drive would be available, and when the laptop 205 was physically decoupled from housing 105 but was still wirelessly coupled with housing 105, the USB disk drive would be available and still appear to the user to be connected with laptop 205. In the same manner, an iPaq or any other device coupled with housing 105 would still appear to be attached to the laptop 205. Moreover, the visual indicators and switches on housing 105 could still represent the status of laptop 205. That is, the wired and wireless connections between the housing 105 and laptop 205 would remain standard regardless. In other words, the wireless operation of the network connectivity module 335 can replicate any or all of the signals available on the PPD, not just the Ethernet connection. Furthermore, in one embodiment, the wireless network connectivity module 335 may also act as a wireless access point, enabling other devices in the vicinity to connect to the network.

Additionally, in one embodiment, laptop 205 may contain a switch 155 that replaces the wireless on/off button with a sliding switch with settings “roam, auto-dock, off”. When set to “roam” laptop 205's wireless router acts as a conventional wireless adaptor and does not connect to the dock. When set to “auto-dock” laptop 205 turns on and connects whenever laptop 205 is removed from the dock. When set to “off” the wireless router of laptop 205 is disabled (to save battery power, or while aboard an airplane).

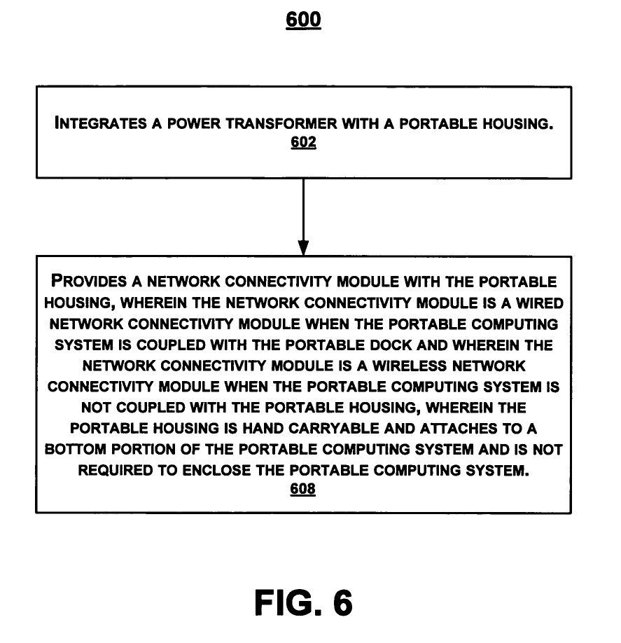

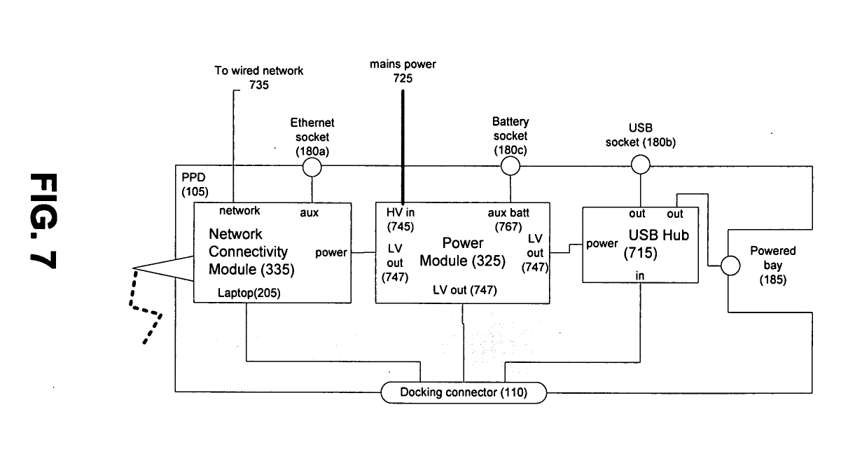

Referring now to FIG. 6, a flowchart of an exemplary method for using a portable dock to increase portability of a portable computing system is shown according with one embodiment of the present invention. One embodiment fits seamlessly onto the back of a laptop 205, allowing the user to carry one slightly-larger device rather than a collection of separate items. Moreover, one embodiment provides seamless wireless connectivity. That is, a user can plug in the PPD then use the laptop wirelessly.

With reference now to 602 of FIG. 6 and to FIG. 3, one embodiment integrates a power transformer 325 with a portable housing 105. In one embodiment, portable housing 105 (as shown in FIG. 2A) is tapered from a first height at a front side to a second height at a back side to provide an angled laptop keyboard which some users prefer for portable computing system 205.

Furthermore, one embodiment couples at least one signal light 160, of FIG. 1C, with housing 105, wherein at least one signal light 160 provides status information for portable dock 105 and portable computing system 205 coupled therewith (as shown in FIG. 2C). In addition, one embodiment, couples at least one switch 155 with housing 105, wherein at least one switch 155 changes at least one operational characteristic of portable dock 105 or portable computing system 205 coupled therewith.

Referring now to 604 of FIG. 6 and to FIG. 3, one embodiment provides a network connectivity module 335 with portable housing 105, wherein network connectivity module 335 is a wired network connectivity module when the portable computing system 205 (of FIG. 5A) is coupled with the portable dock 105 and wherein the network connectivity module 335 is a wireless network connectivity module when portable computing system 205 (of FIG. 5A) is not coupled with portable housing 105. Moreover, in one embodiment, portable housing 105 is hand carryable and attaches to a bottom portion of portable computing system 205 and is not required to enclose portable computing system 205.

In addition, in one embodiment, at least one recharging bay (e.g., 185 of FIG. 3 or 185a,b,c of FIG. 4) with housing 105, wherein recharging bay 185 is utilized for storing and recharging portable items selected from the list of portable items including: a mouse, a presentation remote, a wireless headset, a battery and an iPaq.

Another embodiment provides a power cord stowage area 170 with the portable housing 105. For example, the power cord stowage is on a handle 165 of portable housing 105 or else a space in housing 105 is provided for power cord stowage. In addition, in one embodiment, a space 372 for storing an adapter attached to the power cable 172 within the power cable stowage area 170 is also provided.

An Ethernet cord stowage area 190 may also be integrated with portable housing 105. As described in detail herein, Ethernet cord stowage area 190 may include a cord retractor or may simply involve an area either outside or inside housing 105 at which the loose end of Ethernet cord 192 may be stored.

For security purposes, one embodiment also integrates a security cable 135 with housing 105, security cable 135 having one end fixedly coupled with housing 105. In so doing, security cable 135 is capable of securing portable dock 105 either with or without portable computing device 205.

With reference now to FIG. 7, a block diagram of an exemplary portable dock system is shown in accordance with one embodiment of the present invention. The exemplary portable dock system 700 is a simple case wherein the wireless connectivity module 335 does not also connect non-networking signals to laptop 205. However, it is appreciated that exemplary portable dock system 700 may include wireless connectivity module 335 which does connect non-networking signals to laptop 205.

Moreover, exemplary portable dock system 700 may include a plurality of devices, connections, and options which are not shown due to the almost limitless number of configurations, set-ups and other preferences, which are available within the scope of the present claimed invention. Thus, for purposes of brevity and clarity the present exemplary portable dock system 700 is shown merely as one of a plurality of possible embodiments.

Referring still to FIG. 7, portable dock system 700 includes PPD housing 105, network connectivity module 335, power module 325, docking connector 110 and powered bay 185. In one embodiment, network connectivity module 335 is coupled with an Ethernet socket 180a, a wired network 735 and laptop 205. As stated herein, the network connectivity module 335 may also include a wireless connection with laptop 205 wherein any or all devices coupled with housing 105 are provided as part of the wireless connection. Further module details and operations are previously described herein and are not repeated merely for purposes of brevity and clarity.

Moreover, portable dock system 700 also includes an Ethernet socked 180a, a USB socket 180b and a battery socket 180c. In general, each socket is one of a plurality of possible port 180 options available to portable dock system 700. Furthermore, although only single versions of the ports 180 are shown, embodiments are well suited to more or fewer of each port 180. Thus, the present configuration is one of a plurality of possible configurations and is provided merely for purposes of brevity and clarity.

In FIG. 7, the main power 725 is shown entering the high voltage input 745 of power module 325. Power module 325 then provides a plurality of low voltage outputs 747. In one embodiment, low voltage outputs 747 are provided to the USB hub 715, the docking connector 110 (e.g., to laptop 205), to network connectivity module 335 and also to an auxiliary battery 767 at battery socked 180c.

In one embodiment, portable dock system 700 also includes a USB hub 715. In general, USB hub 715 provides USB capabilities for portable dock system 700. For example, USB hub 715 provides USB capabilities in the form of a port such as USB socket 180b as well as in the form of a powered bay 185. Although USB hub 715 is one of only three modules provided in FIG. 7, the modules such as USB hub 715 are exemplary. That is, the exemplary description and operation of USB hub 715 provided herein parallels the operation of a plurality of other modules. For example, other modules may include, but are not limited to, Bluetooth modules, serial modules, parallel modules, personal system PS/2 modules, VGA modules, and the like.

Thus, embodiments of the present invention provide an automated portable dock for a portable computing system. Embodiments further provide a portable dock that fits onto the back of the laptop, allowing the user to carry one slightly-larger device rather than a collection of separate items. Moreover, embodiments described herein provide a simpler and more efficient means of transporting a plurality of portable computing device peripherals with a significantly reduced chance of forgetting anything. Embodiments also provide an automated portable dock for a portable computing system that provides seamless wired and wireless connectivity.

Embodiments of the present invention are thus described. While the present invention has been described in particular embodiments, it should be appreciated that the present invention should not be construed as limited by such embodiments, but rather construed according to the following claims.

We claim:

1. A portable dock for a portable computing system, comprising:
a housing for attaching to a docking port of a portable computing system, wherein said housing is hand carryable and is not required to enclose said portable computing system;
a power supply transformer coupled with said housing; and
a network connectivity module coupled with said housing, wherein said network connectivity module is a wired network connectivity module when said portable computing device is coupled with said portable dock and wherein said network connectivity module is a wireless network connectivity module when said portable computing system is not coupled with said portable dock.

2. The portable dock of claim 1 wherein said housing further comprises:
a front portion at a first height; and
a back portion at a second height;
wherein said housing is tapered from said first height to said second height to provide an angled laptop keyboard platform for said portable computing system.

3. The portable dock of claim 1 further comprising:
at least one visual indicator coupled with said housing, said at least one visual indicator for providing status information for said portable dock and said portable computing system coupled therewith.

4. The portable dock of claim 1 further comprising:
at least one selector coupled with said housing, said at least one selector for changing at least one operational characteristic of said portable dock or said portable computing system coupled therewith.

5. The portable dock of claim 1 further comprising:
a power cable stowage area having a power cable associated therewith, said power cable stowage area coupled with said housing, said power cable stowage area for reducing a footprint of a stowed power cable with respect to said housing;
an Ethernet cord stowage area coupled with said housing, said Ethernet cord stowage area for reducing a footprint of a stowed Ethernet cable with respect to said housing; and
at least one recharging bay contained within said housing.

6. The portable dock of claim 5 wherein said recharging bay is utilized for storing and recharging portable items selected from the list of portable items including: a mouse, a presentation remote, a wireless headset, a battery and an iPaq.

7. The portable dock of claim 1 further comprising:
a security cable having one end fixedly coupled with said housing, said security cable for securing said portable dock either with or without said portable computing device.

8. The portable dock of claim 5 wherein said power cable stowage further comprises a space for storing an adapter attached to said power cable.

9. A method for using a portable dock to increase portability of a portable computing system comprising:
integrating a power transformer with a portable housing; and
providing a network connectivity module with said portable housing, wherein said network connectivity module is a wired network connectivity module when said portable computing system is coupled with said portable dock and wherein said network connectivity module is a wireless network connectivity module when said portable computing system is not coupled with said portable housing;
wherein said portable housing is hand carryable and attaches to a bottom portion of said portable computing system and is not required to enclose said portable computing system.

10. The method for using portable dock to increase portability of a portable computing system as recited in claim 9 further comprising:
tapering said portable housing from a first height at a front side to a second height at a back side to provide an angled laptop keyboard platform for said portable computing system.

11. The method for using portable dock to increase portability of a portable computing system as recited in claim 9 further comprising:
coupling at least one signal light with said housing, said at least one signal light for providing status information for said portable dock and said portable computing system coupled therewith; and
coupling at least one switch with said housing, said at least one switch for changing at least one operational characteristic of said portable dock or said portable computing system coupled therewith.

12. The method for using portable dock to increase portability of a portable computing system as recited in claim 9 further comprising:
coupling at least one recharging bay with said housing, wherein said recharging bay is utilized for storing and recharging portable items selected from the list of portable items including: a mouse, a presentation remote, a wireless headset, a battery and an iPaq.

13. The method for using portable dock to increase portability of a portable computing system as recited in claim 9 further comprising:
integrating a security cable with said housing, said security cable having one end fixedly coupled with said housing, said security cable for securing said portable dock either with or without said portable computing device.

14. The method for using portable dock to increase portability of a portable computing system as recited in claim 9 further comprising:
providing a power cord stowage area with said portable housing;
integrating an Ethernet stowage area with said portable housing; and
providing a space for storing an adapter attached to said power cable within said power cable stowage area.

15. A portable dock for a portable computing device, comprising:
a hand carryable portable power dock for attaching to a bottom portion of said portable computing device, said portable power dock not required to enclose said portable computing device;
a power supply transformer coupled with said power cable, said power supply transformer for transforming a power source into a usable power supply for said portable computing device; and
a network connectivity module coupled with said portable power dock, wherein said network connectivity module is electrically coupled to said portable computing device when said portable computing device is coupled with said portable dock and wherein said network connectivity module is a wireless network connectivity module when said portable computing device is not coupled with said portable dock.

16. The portable dock of claim 15 wherein said portable power dock has a front portion at a first height and a back portion at a second height and said portable power dock is tapered from said first height to said second height to provide an angled laptop keyboard for said portable computing device.

17. The portable dock of claim 15 further comprising:
at least one LED coupled with said portable power dock, said at least one LED for providing status information for said portable dock and said portable computing device coupled therewith; and
at least one switch coupled with said portable power dock, said at least one switch for changing at least one operational characteristic of said portable dock or said portable computing device coupled therewith.

18. The portable dock of claim 15 further comprising:
a power cable stowage area having a power cable associated therewith, said power cable stowage area coupled with said portable power dock, said power cable stowage area for reducing a footprint of a stowed power cable with respect to said portable power dock, said power cable stowage further comprising a space for storing an adapter attached to said power cable;
an Ethernet cord coupled with said portable power dock, said Ethernet cord retractable into said portable power dock; and
at least one recharging bay coupled with said portable power dock.

19. The portable dock of claim 18 wherein said recharging bay is utilized for storing and recharging portable items selected from the list of portable items including: a mouse, a presentation remote, a wireless headset, a battery and an iPaq.

20. The portable dock of claim 15 further comprising:
a security cable and lock having one end fixedly coupled with said portable power dock, said security cable and lock for securing said portable dock either with or without said portable computing device.
